(19) United States
(12) Patent Application Publication
(10) Pub. No.: US 2026/0073349 A1
(43) Pub. Date: Mar. 12, 2026

(54) ARRIVAL TIME FORECASTING MIXTURE OF EXPERTS MODEL SYSTEM WITH TIME SERIES FEATURES

(71) Applicant: DoorDash, Inc., San Francisco, CA (US)

(72) Inventors: Ziqi Jiang, Santa Clara, CA (US); Chi Zhang, Duluth, GA (US); Qingyang Xu, Sunnyvale, CA (US); Lewis Warne, San Francisco, CA (US); Hubert Jenq, San Francisco, CA (US); Jianzhe Luo, Clyde Hill, WA (US); Pradeep Varma Mudunuru, Snohomish, WA (US)

(73) Assignee: DoorDash, Inc., San Francisco, CA (US)

(21) Appl. No.: 19/322,443

(22) Filed: Sep. 8, 2025

Related U.S. Application Data
(60) Provisional application No. 63/691,989, filed on Sep. 6, 2024.

(51) Int. Cl. G06Q 10/083

(52) U.S. Cl. CPC G06Q 10/0843

(57) ABSTRACT

Methods, systems, and machine learning models for providing accurate estimate time of arrival (ETA) predictions are disclosed, particularly in the context of item fulfillment services. Input features including continuous, numerical, categorical, and time series features can be processed using an initial set of encoders. The resulting embeddings (and other applicable data) can be applied to a set of “expert” encoders. The embeddings produced by the expert encoders can be combined and processed using a multilayer perceptron, which can return one or more estimated arrival time predictions. Such predictions can correspond to multiple tasks and can include both point estimate predictions and distribution estimate predictions, e.g., predictions describing a probability density function of estimated arrival times. Interval regression can be used to produce distribution estimates, and machine learning models according to embodiments can be trained using multitask learning to produce estimated arrival time predictions for multiple tasks.

### BACKGROUND

Estimated time of arrival (ETA) can comprise an estimate of when something will arrive somewhere. In the context of an item fulfillment service, estimated time of arrival can comprise an estimate of the time it will take for a user to receive their item after placing a fulfillment request. A large number of factors can influence the time it takes to complete a fulfillment request, and as such, accurate arrival time forecasting is a difficult task. Many arrival time forecasting systems produce forecasts that are inaccurate or fail to communicate the uncertainty inherent in estimated time of arrival predictions.

Embodiments address these and other problems, individually and collectively.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

Embodiments of the present disclosure are directed to a novel estimated time of arrival prediction model that leverages advanced machine learning techniques to improve estimated accuracy over previous time of arrival prediction models. Embodiments of the present disclosure can use both embeddings of categorical, continuous, and numerical features, in addition to time-series data to predict estimated arrival times. Additionally, embodiments of the present disclosure can use a “Mixture of Experts” (MoE) architecture, in which multiple encoder sub-models (each an “expert”) are used to encode relevant ETA predictive information from input features. These encoder sub-models can include multiple feature, categorical, and time series encoders.

By using these specialized encoders, machine learning models according to embodiments can adapt to various scenarios and learn complex relationships from both embeddings and time series data, thereby capturing both temporal and spatial patterns. Further, some embodiments can use multitask learning, enabling machine learning models according to embodiments to simultaneously predict multiple related outcomes. Additionally, some embodiments use a novel probabilistic modeling approach, enabling machine learning models according to embodiments to accurately quantify the uncertainty of ETA forecasts.

Experiments have shown that embodiments of the present disclosure achieve a 20% relative improvement to estimated arrival time accuracy relative to previous arrival time forecasting methods, e.g., those using tree-based models as described above. By providing more accurate estimated arrival time forecasts, embodiments of the present disclosure improve the operational efficiency of item fulfillment services and enable such services to provide more accurate forecasts to users, thereby improving user satisfaction.

One embodiment is directed to a computer-implemented method. A computer system can receive a request for a delivery from an end user device. The computer system can obtain feature information comprising one or more continuous features, one or more categorical features, and one or more time series features. The feature information can include (1) retrieval information associated with a retrieval location from which an item is to be delivered by a transporter and (2) transporter information associated with a plurality of transporter devices of transporters that are currently active for the retrieval location. The computer system can use an initial encoding layer of a machine learning model to generate an initial embedding set based on the one or more continuous features, one or more categorical features, and one or more time series features. The computer system can generate a plurality of secondary embeddings based on the initial embedding set using an expert encoding layer of the machine learning model. The expert encoding layer can comprise a time series encoder, a categorical encoder, and a multiple feature encoder. The computer system can generate one or more estimated arrival time predictions corresponding to the delivery based on the plurality of secondary embeddings using a multilayer perceptron. The computer system can provide at least one of the estimated arrival time predictions to the end user device.

In some embodiments, the one or more estimated arrival time predictions can comprise a point estimate and/or a distribution estimate.

In some embodiments, a first estimated arrival time prediction of the one or more estimated arrival time predictions is generated prior to the item being selected.

In some embodiments, a second estimated arrival time prediction of the one or more estimated arrival time predictions is generated after the item is selected.

In some embodiments, the time series encoder comprises a transformer encoder, the categorical encoder comprises a deep neural network comprising a cross-interaction mechanism, and the multiple feature encoder comprises a deep neural network with a deep component.

In some embodiments, the initial embedding set comprises one or more continuous feature embeddings, one or more categorical feature embeddings, and one or more positional embeddings. Generating the plurality of secondary embeddings can include generating, by the time series encoder, a time series embedding based on the one or more time series features and the one or more positional embeddings. The multiple feature encoder may generate an implicit interaction embedding based on the feature information, the one or more continuous feature embeddings, the one or more categorical feature embeddings, the one or more positional embeddings, or any combination thereof. The categorical encoder may generate an explicit interaction embedding based on the one or more categorical features and the one or more categorical feature embeddings.

In some embodiments, the one or more categorical features can include one or more non-numerical features associated with the delivery. The one or more non-numerical features can include pickup location, drop off location, store type, item taxonomy, or any combination thereof.

In some embodiments, the one or more time series features can include a sequence of time signals obtained during a time period. Each time signal of the sequence of time signals can include one or more data points associated with the delivery and collected during one or more time intervals of the time period.

In some embodiments, the output layer can include a gating mechanism associated with (i) a multilayer perceptron, (ii) one or more linear functions, (iii) or any combination thereof.

In some embodiments, the one or more estimated arrival time predictions are generated based on the initial embedding set, the plurality of second embeddings, the feature information, or any combination thereof.

In some embodiments, the initial encoding layer can include a single layer perceptron and one or more batch normalization layers.

In some embodiments, one or more normalized inputs may be generated by the single layer perceptron and one or more batch normalization layers based on the feature information, the initial embedding set, or a combination thereof. The one or more normalized inputs may have a fixed dimension. The one or more normalized inputs may be provided to the expert encoding layer, the output layer, or a combination thereof.

In some embodiments, the one or more estimated arrival time predictions can comprise a distribution estimate. The distribution estimate can correspond to a Weibull distribution and can be generated using interval regression.

In some embodiments, the one or more continuous features can include one or more numerical features. The one or more numerical features can include travel duration and item fulfillment subtotals.

Another embodiment is directed to a computer-implemented method for training a machine learning model to generate estimated arrival time predictions. The method can comprise performing an iterative training process until a terminating condition has been met. The iterative training process can include the following steps. A computer system can sample a batch of training feature information comprising a batch of continuous features, a batch of categorical features, and a batch of time series features. The computer system can use an initial encoding layer of the machine learning model to generate an initial embedding set based on the batch of continuous features, the batch of categorical features, and the batch of time series features. The computer system can use an expert encoding layer of the machine learning model to generate a plurality of secondary embeddings based on the initial embedding set. The expert encoding layer can comprise a time series encoder, a categorical encoder, and a multiple feature encoder. The computer system can use an output layer to generate one or more estimated arrival time predictions based on the plurality of secondary embeddings. The computer system can determine one or more loss values based on the one or more estimated arrival time predictions. The computer system can update a parameter set of the machine learning model based on the one or more loss values, thereby training the machine learning model. If the terminating condition has not been met, the computer system can repeat the iterative training process until the terminating condition has been met, otherwise the computer system can complete the iterative training process.

In some embodiments, the estimated arrival time predictions can correspond to a first task and a second task, and the initial encoding layer can include a first task single layer perceptron and a second task single layer perceptron. Additionally, the output layer can include a first task multilayer perceptron and a second task multilayer perceptron. In such embodiments, updating the parameter set of the machine learning model based on the one or more loss values comprises updating parameter sets corresponding to the first task single layer perceptron, the second task single layer perceptron, the first task multilayer perceptron, and the second task multilayer perceptron.

In some embodiments, machine learning model components corresponding to the first task and the second task are trained sequentially.

In some embodiments, machine learning model components corresponding to the first task and second task are co-trained.

In some embodiments, the machine learning model additionally comprises one or more shared model components, and updating the parameter set of the machine learning model comprises updating one or more parameter sets corresponding to the one or more shared model components.

Another embodiment is directed to a computing device comprising one or more processors and a non-transitory computer readable medium coupled to the one or more processors. The non-transitory computer readable medium can comprise instructions for causing the one or more processors to perform any of the computer-implemented methods described above (or elsewhere herein).

Embodiments of the present disclosure are described in more detail with reference to the Detailed Description below.

### Terms

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). The client computer may access this service via a communication network such as the Internet or any other appropriate communication network. A client computer may make requests to server computers including requests for data. As an example, a client computer can request a video stream from a server computer associated with a movie streaming service. As another example, a client computer may request data from a database server. A client computer may comprise one or more computational apparatuses and may use a variety of computing structures, arrangements, and compilations for performing its functions, including requesting and receiving data or services from server computers.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

A “message” may refer to any information that may be communicated between entities. A message may be communicated by a “sender” to a “receiver,” e.g., from a server computer sender to a client computer receiver. The sender may refer to the originator of the message and the receiver may refer to the recipient of a message. Most forms of digital data can be represented as messages and transmitted between senders and receivers over communication networks such as the Internet.

A “user” may refer to an entity that uses something for some purpose. An example of a user is a person who uses a “user device” (e.g., a smartphone, wearable device, laptop, tablet, desktop computer, etc.). Another example of a user is a person who uses some service, such as a person who uses an item fulfillment service, a member of an online video streaming service, a person who uses a tax preparation service, a person who receives healthcare from a hospital or other organization, etc. A user may be associated with “user data,” data which describes the user or their use of something (e.g., their use of a user device or a service). In some circumstances, a user may be referred to as an “end user.”

A “user device” may be any suitable electronic device that can be used by a user. An exemplary user device can process and communicate information to other electronic devices. The user device may include a processor and a computer-readable medium coupled to the processor, the computer-readable medium comprising code, executable by the processor. The user device may also each include an external communication interface for communicating with other entities. Examples of user devices may include mobile devices such as mobile phones and laptop computers, wearable devices (e.g., glasses, rings, watches, etc.), hardware modules in larger devices such as vehicles (e.g., automobiles), etc.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc. Transporters can also include autonomous vehicles such as self-driving cars and unmanned drones.

A “fulfillment request” can be a request to provide a resource in response to the fulfillment request. For example, a fulfillment request can include an initial communication from an end user device to a central server computer for a first service provider computer to fulfill a purchase request for a resource, e.g., a purchase request for food from a restaurant. A fulfillment request can include one or more selected items from a selected service provider. A fulfillment request can also include user features of the end user providing the fulfillment request.

An “item” can include an individual article or unit. An item can be a thing that is provided by a service provider. Items can be goods, For example, bowls of soup, soda cans, toys, clothing, etc. An item can be delivered from a service provider location to an end user location by a transporter.

A “feature” can be an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects facilitate processing and statistical analysis. For image processing, for example, feature values might correspond to the pixels of an image. As another example, when feature vectors represent text, the features may comprise occurrence frequency of textual terms. Feature vectors can be equivalent to the vectors of explanatory variables used in statistical procedures such as linear regression.

“User features” can include attributes or aspects of a user. User features can include features that relate to a user. For example, in the context of an item fulfillment service, user features can include order history, delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the user.

“Service provider features” can include attributes or aspects of a service provider. Service provider features can include features that relate to a service provider. Service provider features can include service provider details, cuisine, ratings, food category, service provider location(s), item production time, promoted items, item cost, and/or other data representative of the service provider and/or items provided by the service provider.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model. One example of a machine learning model is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

### BRIEF DESCRIPTION OF THE DRAWINGS

FIG. 1 illustrates an example distributed computing system able to determine and update pin location for delivery destinations according to some implementations.

FIG. 2 shows a block diagram of a machine learning model according to some embodiments.

FIG. 3 shows two graphs visualizing time and service provider embeddings via t-distributed stochastic neighbor embedding.

FIG. 4 shows a graph comparing the performance of machine learning models according to embodiments that use time series features versus those that do not use time series features.

FIG. 5 shows a graph summarizing the relative improvement of using time series features in some embodiments.

FIG. 6 shows histogram graphs comparing predicted versus ground truth arrival time distributions.

FIG. 7 shows two graphs demonstrating the effectiveness of using interval regression to estimate Weibull parameters and calibration scores.

FIG. 8 shows a diagram of a multitask learning approach according to some embodiments.

FIG. 9 is a flowchart illustrating a method for determining an estimated time of arrival for delivery, according to some embodiments of the present disclosure.

FIG. 10 is a flowchart illustrating a method for training a machine learning model to generate estimated time predictions, according to some embodiments of the present disclosure.

FIG. 11 shows an exemplary computer system according to some embodiments.

### DETAILED DESCRIPTION

In an item fulfillment service or organization (e.g., a delivery service), “providers” (also referred to as “service providers” or “resource providers”) can prepare items for end users upon receiving fulfillment requests from those end users. These items can be retrieved by “transporters” (e.g., delivery drivers) who can then transport the items to their respective end users, thereby servicing the fulfillment request. For example, in a food delivery service, an end user (e.g., a customer) can order a meal from a restaurant (service provider). A delivery driver (transporter) can then pick up that meal and drive it to the end user.

Item fulfillment organizations can provide to the end user a range of an estimated time of arrival so that the end user can anticipate when they will receive their item. The range of an estimated time of arrival can be a range of durations (e.g., 35-40 minutes) or a range of arrival times (e.g, 5:00 P.M. to 5:15 P.M.). By providing an accurate and reliable range of an estimated time of arrival to the end user, item fulfillment organizations can enhance the end user experience. Additionally, accurate estimated arrival time forecasting may improve operational efficiency, as estimated time of arrival forecasts may be used to plan and execute fulfilment requests.

The estimated time of arrival may be presented to an end user at various stages of the item fulfillment process and may be associated with a variety of item fulfillment types. Further, different scenarios can present unique challenges. For example, an end user may encounter the home page of an item fulfillment application and use estimated arrival times presented on the home page to help them decide between service providers. The features available for predicting these estimated arrival times may be limited because these estimated arrival times are generated before the end user has selected the items they wish to order, and the latency of all the features must be low to quickly predict estimated arrival times for all the nearby service providers. In another example, the end user may request an item for pick-up, and features related to available transporters may not be relevant.

Further, there are a variety of item fulfillment types, ranging from food delivery where a transporter picks up prepared meals, to grocery orders requiring in-store shopping, which introduces distinct item fulfillment dynamics. Estimated arrival times may also be subject to unpredictability due to geographic differences and other external factors. As such, many aspects of the delivery process inherently involve uncertainties that can affect the accuracy of estimates. Additionally, for large item fulfillment services, which may handle billions of fulfillments requests annually, time of arrival forecasting can be a difficult task, and even minor errors in individual item fulfillment estimated time of arrival forecasts can accumulate over the course of billions of fulfillment requests.

Tree-based models have previously been used to forecast estimated arrival times in fulfillment requests. Such models often produce reasonable forecasts, but can struggle to capture more complex patterns in data used to forecast estimated arrival time (e.g., traffic conditions, time of day, whether or not there is a holiday or other event, etc.). For large and varied item fulfillment service networks, such tree-based models may be less useful for producing estimated time of arrival forecasts for large scale item fulfillment services.

More specifically, tree-based estimated arrival time models often produce arrival time predictions that have less variance than ground truth arrival times, indicating limited model expressiveness. As such, these tree-based models often had difficulty capturing the full complexity and variability of arrival times, especially in the long tail of arrival time distributions. Additionally, the curse of dimensionality makes it difficult for such models to identify meaningful splits, leading to overfitting and underfitting, particularly for sparse features.

While incorporating feature interactions and temporal dependencies can improve the performance of such models, such feature interactions may need to be manually created, a prospect that is unscalable in practice. Additionally, noisy data worsens dimensionality issues, making it more difficult to extract useful patterns from such data. As such, more accurate methods and systems for estimating arrival times, such as those disclosed herein, may be useful for such large scale item fulfillment services.

### I. DISTRIBUTED COMPUTING SYSTEM

Some implementations relate to a service that includes a network of a plurality of transporters that are paid to pick up and deliver items. End users may place orders through the service for desired items from retrieval locations (e.g., merchants), and the transporters deliver the items to the end users at delivery locations indicated by or otherwise associated with the end users. The system may determine a new pin location for specific retrieval and delivery locations based in part on the latitudes and longitudes captured by transporter devices during prior deliveries. Further, while some examples are described in use with a delivery service, implementations herein are not limited to use with a delivery service, and may be implemented with other systems, services, and the like.

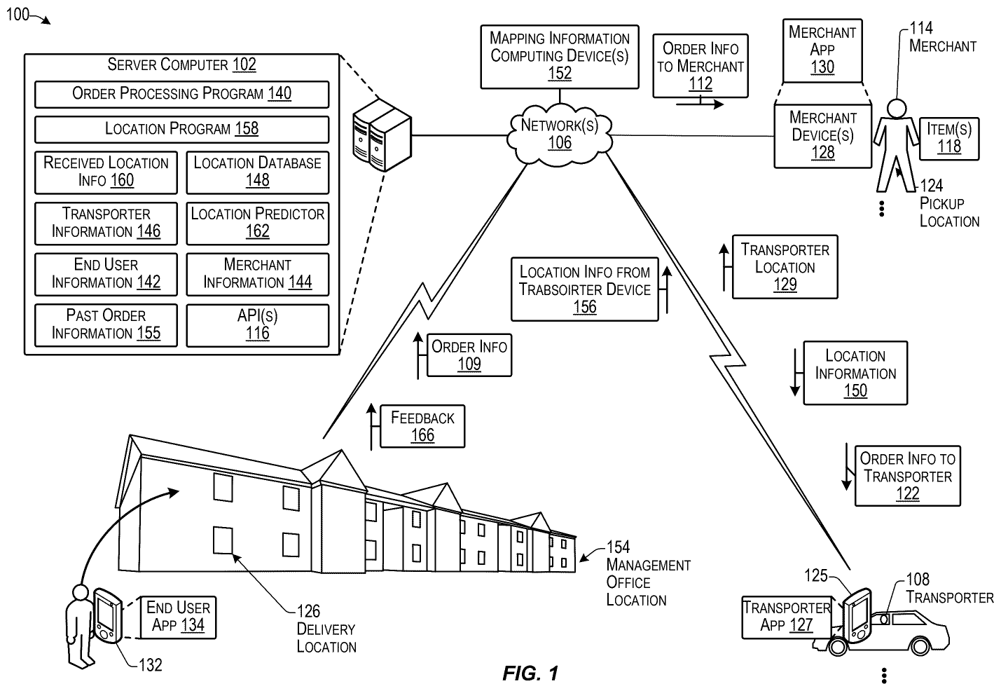

FIG. 1 illustrates an example distributed computing system able to determine and update pin location for delivery destinations according to some implementations. For instance, the system 100 may enable a server computer 102 to store, predict, and update pin locations based on location information received over one or more networks 106 from one or more transporters 108. The predicted pin locations may be subsequently provided to the transporters 108, such as for use in making subsequent retrievals from retrieval locations and subsequent deliveries to the delivery locations.

Some example implementations are described in the environment of server computer 102 that manages a network of transporters 108 for delivering items to end users 110 in high density housing locations and other densely populated locations. However, implementations herein are not limited to the particular examples provided, and may be extended to other service environments, other system architectures, other types of transporters, other types of deliveries, other types of location, and so forth, as will be apparent to those of skill in the art in light of the disclosure herein.

In the illustrated example, server computer 102 may be configured to provide a service to receive, over the one or more networks 106, order information 109 from an end user 110. For instance, the order information 109 may include an indication of an item and an indication of a delivery location. The delivery location may be explicitly specified with the order information or, alternatively, may be implied to be a default delivery location already associated with an end user account of the end user 110. Based on the order information 109 received from the end user 110, the server computer 102 may send order information 112 to at least one particular merchant 114 of a plurality of merchants (i.e. retrieval location from a plurality of retrieval locations) that will provide a requested item 118. Merchant 114 may receive the order information 112, and may respond with a confirmation to confirm that the request for item 118 has been received and item 118 will be provided by merchant 114.

In response to receiving the confirmation from particular merchant 114, server computer 102 may send order information 122 to a transporter device 125 of a selected transporter 108 who, upon accepting the delivery job, will pick up the order from merchant 114 and deliver the order to end user 110. For instance, each merchant 114 may be associated with a respective pickup location 124 (i.e., retrieval location), which may typically be the merchant's place of business. Furthermore, each end user 110 may be associated with a respective delivery location 126, which as mentioned above, may be determined by server computer 102 when order information 109 is received from end user 110.

Order information 122 sent to the transporter device 125 may include item information, the pickup location 124 for the order, the pickup time, the delivery location 126, and a delivery time for the order. Further, while one transporter 108, one end user 110, and one merchant 114 are shown in this example for clarity of illustration, a large number of transporters 108, end users 110, and merchants 114 may individually participate in the system 100.

In the illustrated example, server computer 102 is able to communicate with the transporter device 125 over the one or more networks 106. Each transporter 108 may be associated with a respective transporter device 125 that may execute a respective instance of a transporter application 127. For example, the transporters 108 may use transporter devices 125, such as smart phones, tablet computers, wearable computing devices, laptops, or the like, as further enumerated elsewhere herein, and these transporter devices 125 may have installed thereon the transporter application 127. Transporter application 127 may be configured to receive order information 122 from the server computer 102 to provide a particular transporter 108 with information for picking up a particular order from a merchant's pickup location 124 and for delivering the order to an end user's delivery location 126. Transporter application 127 may further enable the transporter 108 to respond to the server computer 102 to confirm acceptance of a delivery job.

Additionally, in some cases, transporter application 127 may provide server computer 102 with an indication of a current transporter location 129 (also called a location point, such as a retrieval location point or a delivery location point) of a particular transporter 108. For example, the transporter application 127 may obtain the current location from a GPS receiver (not shown in FIG. 1) included onboard the transporter device 125. As mentioned above, the term “GPS” as used herein may include any global navigation satellite system (GNSS) such as the Global Positioning Satellite (GPS) system, the Russian Global Navigation Satellite System (GLONASS), the Chinese BeiDou Navigation Satellite System (BDS), the European Union's Galileo system, the Japanese Quasi-Zenith Satellite System (QZSS), the Indian Regional Navigation Satellite System (IRNSS), any other satellite-based location positioning system, or any similar such system for providing accurate indications of current location to a mobile device. Accordingly the GPS receiver herein may be able to determine transporter location 129 (e.g., latitude and longitude) of the transporter device 125 based on received signals from one or more satellite positioning systems or the like. Additionally, in some examples, the transporter application 127 and the server computer 102 may communicate with each other via one or more application programming interfaces (APIs) 116.

Each merchant device 128 may be associated with a respective merchant 114. Each merchant device 128 may be a computing device, such as a desktop, laptop, tablet, smart phone, or the like, and may include a respective instance of a merchant application 130 that executes on the respective merchant device 128. For example, merchant application 130 may be configured to communicate with server computer 102, such as for receiving the order information 112 and for sending a confirmation. In some examples, the merchant application 130 and the server computer 102 may communicate with each other via one or more APIs 116

In addition, end users 110 may be associated with respective end user devices 132 that may execute respective instances of an end user application 134. For example, the end users 110 may use the end user devices 132, such as smart phones, tablet computers, wearable computing devices, laptops, desktops, or the like, and these end user devices 132 may have installed thereon or may otherwise access end user application 134. End user application 134 may enable end user 110 to select one or more items 118 to purchase from one or more of the merchants 114 to be delivered to the end user 110 by one or more of the transporters 108. For example, end user application 134 may present one or more UIs on a display of the transporter device 132 for enabling end user 110 to select one or more items 118 for an order. In some examples, end user application 134 and server computer 102 may communicate with each other via one or more APIs 116. Additionally, or alternatively, end user application 134 may be a browser, or the like, and end user 110 may navigate to a website or load a web application associated with the service provider 104, and may use the website or web application received from server computer 102 to place an order.

The one or more networks 106 can include any appropriate network, including a wide area network, such as the Internet; a local area network, such an intranet; a wireless network, such as a cellular network, a local wireless network, such as Wi-Fi and/or close-range wireless communications, such as BLUETOOTH®; a wired network; or any other such network, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, server computer 102, merchant device(s) 128, end user device(s) 132, and/or transporter device(s) 125 are able to communicate over the one or more networks 106 using wired or wireless connections and combinations thereof.

In the illustrated example, server computer 102 includes an order processing program 140 that may be executed on the server computer 102 to provide, at least in part, the functionality attributed to server computer 102. Order processing program 140 may receive order information 109 from end user 110 and may associate order information 109 with end user information 142 and merchant information 144. For instance, based on end user identifying information that may be included with order information 109, order processing program 140 may associate particular order information 109 with a particular end user account. Further, based on a particular merchant 114 identified by order information 109, order processing program 140 may associate the order information 109 with a merchant account of a particular merchant 114 to send order information 112 to merchant 114.

In addition, order processing program 140 may access transporter information 146 to determine transporter contact information for sending order information 122 to a particular transporter 108 to determine whether the particular transporter 108 is willing to accept the delivery job of delivering the order to the end user 110. The particular transporter 108 may use transporter application 127 on the transporter device 125 to receive a message with information about the order, and to respond with acceptance of the delivery job if the job is accepted. The particular transporter 108 may subsequently pick up the order from the particular merchant 114 and deliver the order to the particular end user 110 at a specified delivery location 126.

In the case of high density housing locations and other densely populated locations (including for the merchants), transporter 108 may be provided an updated pin location, e.g., determined by analyzing locations points (e.g., measured by GPS) of previous pickups (retrievals) retrieved by order processing program 140 from a location database 148. For example, server computer 102 may maintain location database 148, which may be a relational database or any other suitable type of data structure. Location database 148 may include pin locations for end users (delivery locations) and merchants (retrieval locations) determined from measurements of transporter devices 125. When order information 109 is received from end user device 132, order processing program 140 may correlate the end user account and/or a specified delivery location with location database 148 to determine a current pin location for the end user. Similarly, order processing program 140 may correlate the merchant account and/or a specified retrieval location with location database 148 to determine a current location for the merchant.

Location information 150 can be sent to the transporter application 127 executing on transporter device 125. For example, transporter application 127 may use location information 150 to generate a UI including a map indicating pickup location 124, and then subsequently delivery location 126. As one example, server computer 102 may provide all the location for generating the map in the UI on the transporter device. As another example, transporter application 127 or server computer 102 may provide the location to a third party location computing device 152 that may provide location information 150 to the transporter device 125 to enable presentation of a UI with a map to pickup location 124 and delivery location 126.

When transporter 108 has completed retrieval of the item at pickup location 124, transporter 108 may use transporter application 127 to inform order processing program 140 that the retrieval has been completed. At this time, transporter application 127 can obtain a retrieval location point. Upon receiving the indication of completion, the order processing program 140 may store information related to the order and completion of the order as past order information 155, including the measured retrieval location point.

When transporter 108 has completed delivery of the order to delivery location 126, transporter 108 may use transporter application 127 to inform order processing program 140 that the delivery has been completed. At this time, transporter application 127 can obtain a delivery location point. Upon receiving the indication of completion, the order processing program 140 may store information related to the order and completion of the order as past order information 155, including the measured delivery location point.

Order processing program 140 may receive location information 156 (measured location points) from the transporter device 125 and may provide this received information to a location program 158 that may be executed on server computer 102. For example, the location program 158 may receive location information 156 and may temporarily store the location information with received location information 160. Location program 158 may correlate the received information with the end user account and/or the delivery location 126 in the end user information 142, or with the merchant account and/or pickup location 124 in merchant information 144.

In addition, location program 158 may use the received image as input to a location predictor 162. Location predictor 162 may be executed to determine whether to rely on existing pin location for the end user and/or the merchant (retrieval location) or to use a new central value determined from location information 156 measured from transporter devices 125 at times of pickup or delivery, respectively.

### II. MACHINE LEARNING MODEL

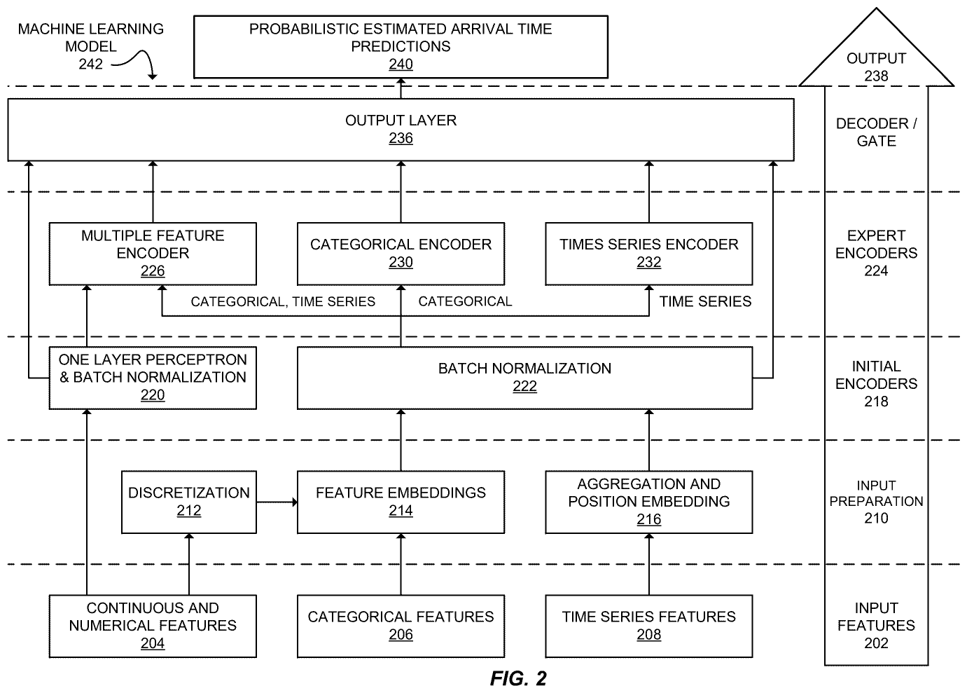

An exemplary machine learning model 242 according to some embodiments is depicted in FIG. 2. Some methods and machine learning models according to embodiments are described with reference to FIG. 2. In brief, input features 202 to the machine learning model 242 can comprise various features, including time series features. During an input preparation step 210, a computer system implementing the machine learning model 242 can prepare these inputs features 202 for processing. A set of initial encoders 218 can be used to process the prepared inputs. The processed inputs can then be input into expert encoders 224. The output of these expert encoders 224 can be input into an output layer 236 (or “gate”) which can produce an output 238 comprising probabilistic estimated arrival time predictions 240. The output layer 236 can be or can include a multilayer perceptron (MLP) decoder.

### A. Features and Feature Engineering

Machine learning models according to embodiments, such as machine learning model 242 can use various types of features in order to produce arrival time estimates. These features can include continuous features and numerical features 204, categorical features 206, and time series features 208, in addition to other various features not depicted in FIG. 2. By using these various types of features, embodiments of the present disclosure are better able to capture complex patterns and relationships between input data, thereby achieving more accurate estimated arrival time forecasts. Some embodiments of the present disclosure can use advanced feature engineering techniques, e.g., during the input preparation step 210, resulting in more accurate probabilistic estimated arrival time predictions 240.

### 1. Continuous and Numerical Feature Engineering

During the input preparation step 210, a computer system can generate feature embeddings 214 (e.g., neural network features) from input features 202, including continuous and numerical features 204. As examples, such features can include travel times (e.g., travel duration) and item fulfillment subtotals. A discretization, quantization, or “bucketization” process 212 can be performed on continuous and numerical features 204 prior to generating the feature embeddings 214, and therefore can also be considered categorical embeddings. Such a discretization process 212 (or any other appropriate technique) can improve model generalizability and better balance the model's focus on sparse features versus dense features, and can result in various additional benefits. As examples, the use of embeddings and quantization can provide improved dimensionality flexibility and can make machine learning model 242 more robust to outliers, as outlier data values may be capped by their respective buckets. As another example, the transformation of continuous and numerical features into discrete features can enable the machine learning model 242 to learn complex patterns within each bucket and better capture non-linear relationships.

### 2. Categorical Features

Likewise, the computer system can generate feature embeddings 214 for categorical features 206. Such categorical features 206 can include data such as service provider identifiers (e.g., the names of different service providers). For large item fulfillment services with large numbers of service providers, such categorical features may have high cardinality, and may provide strong predictive signals, which may be useful for producing accurate probabilistic estimated arrival time predications 240. For various reasons, different service providers may have different service providing times, which may result in different arrival times for users. For example, restaurant service providers may have longer food preparation times than other restaurant service providers for reasons such as cuisine type, popularity, and efficiency. As such, the service provider involved in a fulfillment request may be a strong predictive signal for estimating arrival time, and categorical features 206 corresponding to such service providers may be useful for producing accurate probabilistic estimated arrival time predictions.

Other categorical features 206, such as the time of the day may be a strong predictive signal for estimating arrival times, as how busy a service provider is can change at various times of day. Restaurant service providers, for example, may be more busy during meal times, leading to different arrival times for users. Various other categorical features 206 can include time buckets, pick-up and drop-off locations in various granularities (e.g., the locations at which a transporter delivers an item to a user), service provider type, item taxonomies, assignment segments, etc. In some examples, categorical features can include discretized numerical values.

Various feature encoding methods could conceivably be used capture category-based patterns. Such feature encoding methods can include one-hot encoding, target encoding, and label encoding. However, there are some problems with such encoding methods. For example, one-hot encoding cannot scale efficiently for categorical features with high cardinality due to the “curse of dimensionality”. Additionally, some other encoding methods may not adequately capture patterns related to each category, as such encoding methods require manual effort to capture patterns, and as a result semantic relationships can be lost. For example, in the context of restaurant service providers, it can be difficult to use encodings to learn the similarity between two fast food restaurants compared with other types of restaurants.

By contrast, during input preparation step 210, a machine learning model according to embodiments can generate feature embeddings 214, which can convert sparse feature variables into dense vector representations, thereby enabling machine learning model 242 to learn complex patterns in the input data and thereby learn to produce more accurate probabilistic estimated arrival time predictions 240. The embedding size of each embedded feature can be selected based on the importance of each categorical feature to estimated arrival time predictions, e.g., generally larger embeddings can be produced for generally more important categorical features. This contrasts to methods such as one-hot encoding, in which the size of embeddings is proportional to the cardinality of the respective categorical features. In some embodiments, smaller embedding sizes can be used to avoid overfitting and reduce model size.

Embeddings can be used to map complex data (e.g., words, nodes) into lower dimensional vector space and may be generated using a neural network or similar machine learning model (e.g., CNN, RNN, etc.). Additionally or alternatively, embeddings may be generated usings various algebraic, probabilistic, or geometric transformation techniques (e.g., linear decomposition, probabilistic models, matrix factorization, etc.) that can effectively map high-dimensional data into lower-dimensional vector space.

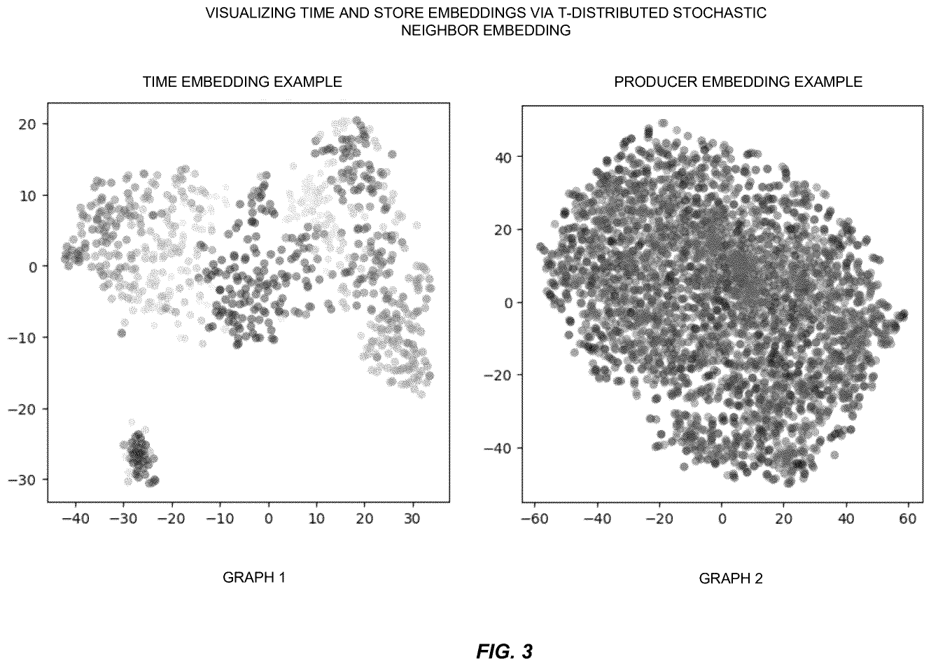

Categorical features 206 and their embeddings may be better understood with reference to the graphs of FIG. 3. Graph 1 shows a time embedding example with two dimensions, and Graph 2 is a service provider embedding example with two dimensions. As shown in Graph 1, embeddings of closer time windows generally cluster together. By contrast, there are multiple clusters in the service provider embedding example of Graph 2. This may be because service provider related patterns tend to be more complicated than the dimensions of service provider types can describe.

### 3. Benefits of Embeddings

Referring back to FIG. 2, in addition to the benefits described above, the use of embeddings 214 can result the machine learning model 242 better capturing category specific patterns. Embeddings 214 can capture intrinsic patterns or similarities between categories, enabling machine learning model 242 to learn to understand relationships from multiple dimensions. By contrast, methods such as target encoding, frequency encoding, and label encoding can only capture limited amounts of information.

As another benefit, the use of embeddings can result in improved generalizations. The representation of quantized dense features can allow machine learning model 242 to better generalize to unseen or rare dense feature values, resulting in more accurate time of arrival estimates in less common cases. For example, outlier dense feature values (e.g., those with extremely high values) can be less impactful during inference, since it is likely that they will be capped by the bucket they fall into, and that such buckets will have sufficient training data to find an appropriate embedding representation.

As a further benefit, the use of embeddings can result in greater flexibility in feature combination. Embedded features can be combined with other numerical features, allowing for more complex feature interactions. Additionally, generated embeddings can be re-used as inputs for other models. In this way, the knowledge learned by estimated arrival time models according to embodiments can be transfer to other item fulfillment related tasks.

### 4. Incorporating Time Series Features

The demand for item fulfillment services can change over time, i.e., such services can become more or less busy depending on time. In addition, the supply for item fulfillment services can also change over time. At some times, there may be more or less service providers and transporters producing and delivering items to users. Generally, under conditions in which there is relatively static and predictable supply and demand, it may be easier to produce accurate estimated arrival times. However, under other conditions, e.g., those in which there is an undersupply of transporters, it can be difficult to produce accurate estimated arrival times, even with data (e.g., features) relating to the how busy the item fulfillment service is, the state of supply, the state of demand, etc. Such features can be noisy due to their volatility and high granularity, which can make it difficult for machine learning models to identify patterns in such features.

Machine learning models according to embodiments, such as machine learning model 242 can address this problem by incorporating time series features 208. Such time series features 208 may contain information enabling machine learning model 242 to produce accurate probabilistic estimated arrival time predictions 240. For example, there may be a strong correlation between the duration of previous fulfillment requests and subsequent fulfillment requests within relatively small time windows. As an example, if it generally takes a long time to complete a given fulfillment request (due, e.g., to transporter undersupply), then it will often take a long time to complete a subsequent fulfillment request, as queued up fulfillment requests will also likely be impacted. As such, time series features 208 such as the duration of previous fulfillment requests enables machine learning models according to embodiments to more quickly response to dynamic changes in item fulfillment services, and thereby improves their accuracy at estimating arrival times.

In some embodiments, time series signals can be collected on a minute level frequency and provided to machine learning models such as machine learning model 242. These can include, for example, the average fulfillment request volume per minute in the past 30 minutes. By comparing these values against the average value in the past 30 minutes, it is possible to evaluate the relative state of user demand, service provider or transporter supply, etc., during these one minute buckets. Various time series features can comprise time series data of different lengths, comprising different numbers of buckets, or comprising different bucket sizes.

In some cases, features such as average order volume can be sparse for small time buckets (e.g., one minute time buckets). As such, in some embodiments, during input preparation step 210, time series features 208 can be aggregated and combined with learnable positional embeddings (e.g., in aggregation and position embedding block 216). For example, for one minute time buckets, the aggregate value of five minutes of buckets can be combined with learnable positional embeddings. As later processing by the time series encoder 232 may have quadratic time complexity with respect to the size of input time series data, aggregation can help improve the speed and efficiency of producing probabilistic estimated arrival time predictions, which may be helpful for addressing latency issues and which may enable Service Level Objectives (SLOs).

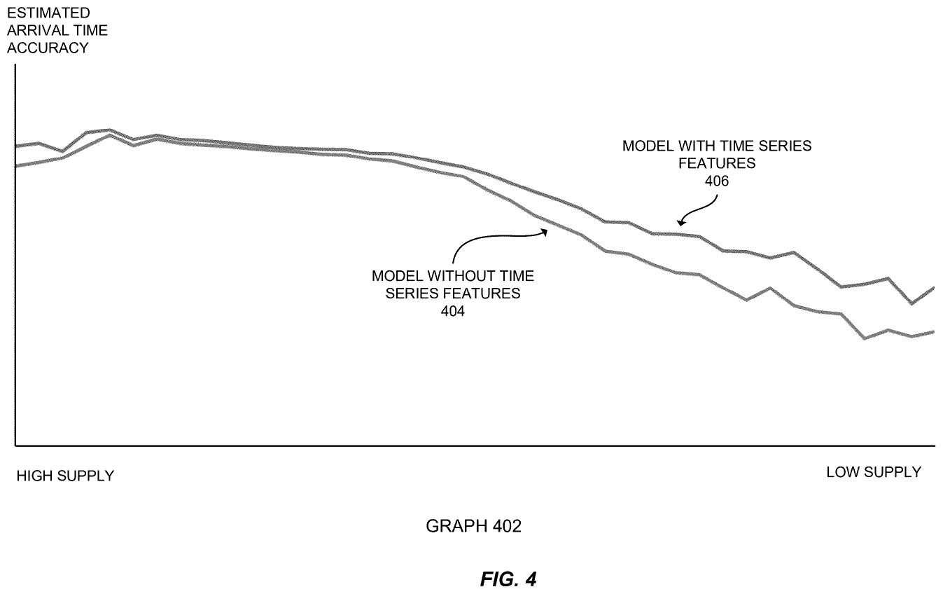

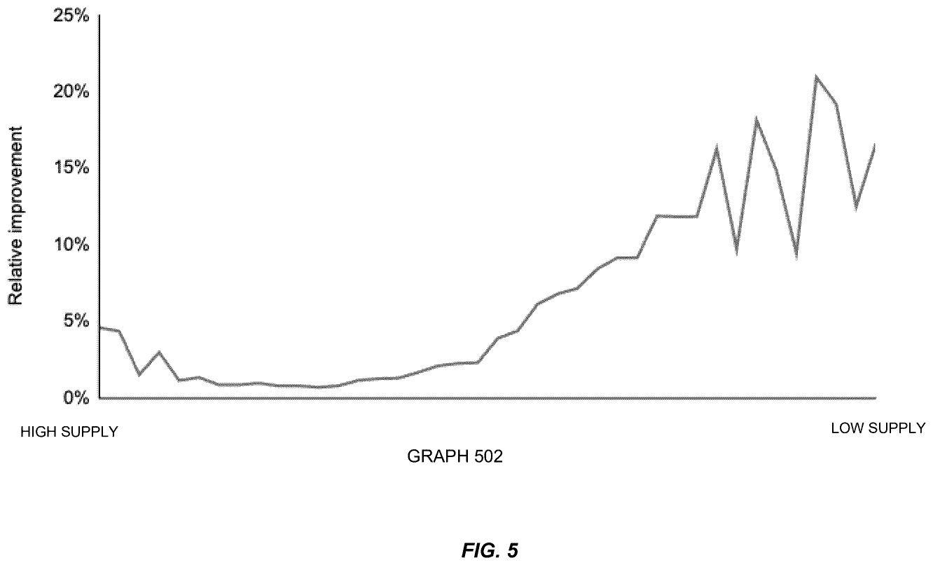

Incorporating time series features generally improves the accuracy of probabilistic estimated arrival time predictions 240 according to embodiments. FIG. 4 shows the effectiveness of including time series features on estimated arrival time accuracy. Two machine learning models according to embodiments were created and trained. One of these models used time series features to predict arrival times and the one model did not. The performance of the model without time series features 404 and the model with time series features 406 are graphed in graph 402 of FIG. 4. While the model with time series features 406 generally outperforms the model without time series features 404, it more significantly outperforms the model without time series features 404 when there is an undersupply of transporters. FIG. 5 shows a graph 502 summarizing the relative improvement from including time series features, i.e., summarizing the difference between the lines plotted in graph 402. Graph 502 shows an improvement of 10%-25% during periods of transporter undersupply for an item fulfillment service. Graphs 402 and 502 suggest that machine learning models according to embodiments that use time series features have better adaptability to changing conditions over time.

### B. Initial Encoders

Referring back to FIG. 2, the embeddings and some continuous and numerical features can be processed by initial encoders 218 prior to further processing by expert encoders 224. These initial encoders can include a one layer perceptron and batch normalization layer 220 as well as a batch normalization layer 222. Additionally or alternatively, the initial encoders 218 can include Principal Component Analysis (PCA) (Khaledian et al. 2025), feature hashing (Argerich et al. 2016), matrix factorization methods (Qiu et al. 2019), and other methods of reducing the dimensionality of data. Continuous and numerical features 204 can be processed by the one layer perceptron and batch normalization layer 220. The one layer perceptron and batch normalization layer 220 can convert the input data into a fixed dimension, which can normalize feature values and facilitate the addition or removal of features prior to providing them to later expert encoders such as multiple feature encoder 226. Embeddings 214 and aggregated time series data and embeddings can be processed by batch normalization layer 222 (e.g., independently).

### C. Mixture of Experts Encoders

In contrast to tree-based methods described above, machine learning models according to embodiments, such as machine learning model 242, can use a “Mixture of Experts” (MoE) architecture, which can include expert encoders 224. As described further below, machine learning model 242 can additionally incorporate a gating mechanism (e.g., via output layer 236), thereby adaptively combining learned interactions based on the input. Such expert encoders 224 can include a multiple feature encoder 226, categorical encoder 230, and time series encoder 232. Each expert encoder can act as an “expert” in processing different aspects of the input data. In this way, the Mixture of Experts architecture enables machine learning model 242 to leverage the strengths of different expert encoders 224 (which may have different structures including, but not limited to neural network, linear algebraic, probabilistic, and autoregressive structures), each of which can be specialized in capturing specific aspects of the relationships present within input data. As a result, machine learning models according to embodiments have greater expressiveness and have the capacity to learn various types of information automatically.

### 1. Multiple Feature Encoder

The multiple feature encoder 226 can receive both embedding features and time series features and may comprise a deep neural network that processes inputs through multiple layers. The multiple feature encoder 226 may include a Deep Component (Guo et al. 2017). Additionally or alternatively, the multiple feature encoder 226 may be a deep neural network (Wang et al. 2023). The input of the multiple feature encoder 226 can include continuous features, numerical features, embeddings 214, and aggregated time series features. Further, in some embodiments, original feature values (i.e., feature values that were used to generate embeddings) can be provided to multiple feature encoder 226, thereby avoiding precision loss due to discretization. As a result, machine learning model 242 can be more flexible in evaluating different types of patterns. In general, multiple feature encoder 226 can capture general feature interactions and can also learn hierarchical representations of input features. Multiple feature encoder 226 can be particularly effective at learning and understanding complex, non-linear relationships between various input features. As such, multiple feature encoder 226 may generate implicit interaction embeddings that capture implicit interactions between the various inputs to the multiple feature encoder 226.

In some embodiments, the multiple feature encoder 226 can be a deep neural network (DNN) that models implicit interactions (e.g., as described in section 3.3 of Wang et al. 2023). The DNN may include with embedding layers feeding into multiple fully connected layers, which can enable the multiple feature encoder 226 to capture higher-order, implicit, and nonlinear feature interactions as described with respect to the deep component of Guo et al. (section 2.1, Guo et al. 2017). Such models may include an embedding layer to compress input vectors to low-dimensional, dense real-value vectors before further feeding into a first hidden layer.

Additionally or alternatively, the multiple feature encoder 226 can be or can utilize other types of modules including but not limited to Multi-Head Self Attention, MLP variant modules, or other similar modules capable of capturing deep implicit non-linear patterns.

### 2. Categorical Encoder

The expert encoders 224 can also include categorical encoder 230, which may be similar to the Deep and Cross Network Encoder (Version 2) for recommendation models (Wang et al. 2020). In some embodiments, the categorical encoder 230 may be a neural network that includes a factorization machine (FM) component (Guo et al. 2017). Additionally or alternatively, the embedding encoder 230 can include a gated cross network (Wang et al. 2023). Additionally or alternatively, the categorical encoder 230 may be similar to models described in Li et al. (e.g., Deep Cross Network v3, Shallow & Deep Cross Network v3, the Deep Cross RNN, etc.) (Li et al. 2024). In some implementations, the categorical encoder 230 may include cross processing performed using recurrent neural networks (RNNs) (Zhou et al. 2023). Categorical encoder 230 can define learnable crossing parameters per layer as low-rank matrices, and the input to the categorical encoder 230 can include embeddings of categorical features and bucketized numerical features. The categorical encoder 230 can effectively model the complexities and interdependencies between temporal, spatial, and fulfillment request related features. Additionally, the depth of the cross and the complexity of the interactions are constrained by the number of cross layers and the rank of cross matrices, leading to both a regulatory effect and better computation efficiency. The output of the categorical encoder 230 can be embeddings generated based on the categorical features and bucketized numerical values. For example, the categorical encoder 230 may generate continuous feature embeddings that capture explicit feature interactions.

As a particular example, the categorical encoder 230 may include cross-interactions mechanisms. Such a categorical encoder can capture explicit pairwise feature interactions and may have higher interpretability via explicit modelling and thus may be a cross-interactions encoder. The categorical encoder 230 may reuse embeddings and may be capable of processing sparse embeddings. In some embodiments, the categorical encoder 230 may be implemented using a factorization machine (FM) layer that acts as an explicit cross interaction component modeling second-order (e.g., pairwise) interactions. Additionally or alternatively, the categorical encoder 230 may include a gated cross layer that explicitly computes bounded-degree interactions using a Hadamard product of original and cross features, and a learned gate applied to each cross layer (e.g., as described in section 3.2 of Wang et al. 2023). In some implementations, the categorical encoder 230 may be implemented using exponential feature crossing to explicitly model high-order interactions.

Additionally or alternatively, the categorical encoder 230 can be or can utilize other types of modules including but not limited to Self-Attention Cross Layers (Song et al. 2019), Compressed Interaction Networks (Lian et al. 2018), and Polynomial Interaction Modules (Guo et al. 2017). In some implementations, the categorical encoder 230 can include self-attention interaction layers that learn weighted interactions between features at each layer as described with respect to an interacting layer in Song et al. (section 4.4 of Song et al. 2019). Such self-attention interaction layers can act as a cross network. Additionally or alternatively, the categorical encoder 230 can include a compressed interaction network (CIN) as described in section 3.1 of Lian et al. (Lian et al. 2018). In some examples, the polynomial interaction modules may be a superset of factorization machines (FMs) (Guo et al. 2017).

### 3. Time Series Encoder

Expert encoders 224 can also include a time series encoder 232, which may use self-attention mechanisms. Time series encoder 232 can learn representations from this sequential time series data and can model sequential dependencies and relationships in sequential features. The input to the time series encoder 232 can include time series features, which may comprise sequences of signals. The time series encoder 232 may additionally receive positional embeddings generated by aggregation and position embedding block 216. In this way, machine learning model 242 can learn a representation (e.g., time series embeddings) for contextual snapshots of item fulfillment service dynamics (e.g., user demand, service provider or transporter supply, etc.) in given time windows.

While such sequences of signals can also be applied to multiple feature encoder 224 to capture non-sequential hierarchical patterns and complex feature interactions, multiple feature encoder 224 might ignore sequence order information. By contrast, time series encoder 232 can learn long-range dependencies and contextual relationships within sequences using self-attention, which may be useful for arrival time predictions, e.g., due to the strong temporal dependencies between arrival time predictions. By modeling the temporal relationships between volume, fulfillment request cycles, supply, and demand, and temporal dynamics of item fulfilment networks, using time series encoder 232 can enable machine learning model 242 to quickly respond to dynamic changes in an item fulfillment service.

As a non-limiting example, time series signals may be captured on minute-level frequencies and can be conveyed as an average amount per time interval over a larger time period (e.g., average order volume per minute over a 30 minute time period).

As a particular example, the time series encoder 232 may be a transformer model. As described above, transformer models can include attention a self-attention layer that enables the model to weigh relationships between all elements in a sequence (e.g., a time series) at once. Additionally or alternatively, the time series encoder 232 may be a recurrent neural network (RNN), long short-term memory (LSTM) network, gated recurrent unit (GRU) network, or similar neural network. Additionally or alternatively, the time series encoder 232 may be a machine learning model capable of encoding sequential temporal data, including but not limited to, autoregressive (AR) models (e.g., AR, moving average (MA), autoregressive moving average (ARMA), autoregressive integrated moving average (ARIMA), etc.).

By each processing different input features, the expert encoders 224 can each learn to generate representations corresponding to different aspects of the information that can be useful for predicting arrival times.

### 4. Combining Expert Opinions

As described above, machine learning models according to embodiments can harness the strengths of different neural network structures while maintaining a manageable level of complexity via the Mixture of Experts architecture of machine learning model 242. The outputs of the one layer perceptron and batch normalization layer 220, multiple feature encoder 226, categorical encoder 230, and time series encoder 232 can be combined into a single encoding or embedding. The single encoding or embedding can be used as an input to a linear formula, machine learning model, or other combination of modules configured to optimize the selection and inclusion of inputs from each of the expert encoders (e.g., using conditional computations, dynamic routing, regularization, etc.), which can be input into output layer 236. In some embodiments, the dimensions of the output of each expert encoder 224 can be similar sizes. From this input, the output layer 236 can generate probabilistic estimated arrival time predictions 240, which can comprise either point estimated arrival time predictions or distributions of estimated arrival time predictions, as described further below.

Additionally, as described in the Multitask Learning Section further below, the probabilistic estimated arrival time predictions 240 can correspond to various different task. The output layer 236 can be or can include a gating mechanism for selecting and/or applying weights to the outputs of the one layer perceptron and batch normalization layer 220, multiple feature encoder 226, categorical encoder 230, and time series encoder 232. In a preferred embodiment, output layer 236 can be or can include a multilayer perceptron (MLP). An output layer 236 that is or includes an MLP may dynamically control information between layers of the MLP, which can combine and utilize outputs from all encoders simultaneously. The use of an MLP may enable the machine learning model 242 to perform gating without the inclusion of an additional gating network within the machine learning model 242. Additionally or alternatively, the output layer 236 can be or can include a linear function that uses weighted, conditional, statistical, or similar methods of computation (e.g., linear regression, logistic regression, etc.) for determining an optimal model output based on the outputs of each module (e.g., each expert encoder).

As examples of different tasks, machine learning model 242 can be used to produce both “Explore Stage” estimated arrival time predictions as well as “Checkout Stage” estimated arrival time predictions. In more detail, an end user may encounter the home page of an item fulfillment application and use the home page estimated arrival times to help them decide between service providers. Such home page estimated arrival times may correspond to the Explore Stage. The features available for predicting these estimated arrival times may be limited because the prediction occurs before the end user has selected the items they wish to order, and the latency of all the features must be low to quickly predict estimated arrival times for all the nearby service providers. After placing an item fulfillment request, the user may be presented with new, generally more accurate “Checkout Stage” estimated arrival times. As such, in some embodiments, probabilistic estimated arrival time predictions 240 can include both Explore Stage estimated arrival time predictions and Checkout Stage Estimated arrival time predictions.

Unlike some traditional Mixture of Experts architectures, the Mixture of Experts architecture of machine learning model 242 may not use a separate gating network to dynamically weigh the contributions of expert encoders 224 (e.g., a softmax weighted average), instead, machine learning model 242 can use output layer 236 to learn how to effectively combine and utilize the outputs from all encoders simultaneously. Removing the separate gating network improves the efficiency of generating arrival time predictions without meaningfully impacting accuracy.

One of the advantages of machine learning models according to embodiments is their extensibility, as machine learning models according to embodiments can be modified to incorporate additional encoders or other model components without needing to redesign a gating mechanism. As a result, machine learning models according to embodiments can be adapted to handle the integration of new features, making such models more versatile in responding to changing requirements or data patterns. As such, machine learning models according to embodiments can be a useful framework that enables further development of even more accurate arrival time prediction models.

### III. ESTIMATING ARRIVAL TIME DISTRIBUTIONS

As described above, for an item fulfillment service, accurate estimated arrival times can be useful to both users and for the operational efficiency of the item fulfillment service itself. Generally however, it is also useful to be able to quantify and communicate any uncertainly associated with arrival time predictions. Traditional estimated arrival time models often provide a single point estimate, which can be misleading in highly variable systems such as item fulfillment services. While embodiments of the present disclosure can be used to produce single point estimates, they also provide a probabilistic approach to arrival time predictions via a probabilistic base layer, thereby adding another dimension of reliability.

Embodiments of the present disclosure can use various approaches to evaluate or estimate the uncertainty of an arrival time estimate. One such approach is point estimation, which can have a consistent trend with the variance of ground truth data, which can be used to form a formula to translate point estimates to uncertainty. Another such approach is the use of particular sampling techniques. For each estimated arrival time prediction, inference can be performed multiple times with a randomly selected set of nodes being disabled. The distribution formed by all of the individual inference results can be used as the final prediction. Further, embodiments of the present disclosure can predict the parameters of ground truth arrival time distributions. Additionally, embodiments of the present disclosure can segment the possible range of ground truth distributions into buckets, and machine learning models according to embodiments can predict the probability associated with each bucket. By tuning granularity or smoothing techniques, a good estimate of the probability density function can be produced.

In summary, by incorporating a probabilistic base layer, machine learning models according to embodiments can predict distributions of possible arrival times, as an alternative to single estimated time of arrival values. Such distributions can provide useful information about the uncertainty associated with each prediction.

### 1. Challenges of Learning a Weibull Distribution

Fulfillment request times for item fulfillment services, particularly for food fulfillments, appear to follow a long-tailed distribution that cannot be modeled by Gaussian or exponential distributions. The Weibull distribution may better capture the long-tailed nature of fulfillment times and may be more useful for predicting uncertainty. The probability distribution function (PDF) of the Weibull distribution takes the form:

$$f ( t ) = \frac{k}{λ} {( \frac{t - γ}{λ} )}^{k - 1} {e}^{- {( \frac{t - γ}{λ} )}^{k}} if t \geq γ and f ( t ) = 0 if t < γ$$

The parameters k, λ, γ are called the shape, scale and location of the Weibull distribution, and they specify the tail shape, width and minimum of the distribution.

Some machine learning models according to embodiments can learn to predict the parameters k, λ, γ as functions of the input features X. However, in some cases maximizing the log-likelihood under the Weibull distribution may sometimes result in unreasonable predictions, e.g., a negative local γ<0, which means a non-zero chance that a fulfillment request is complete within one minute of placing that fulfillment request, which is generally infeasible in reality. This may be a result of the highly non-linear appearance of parameters k, λ, γ in the log-likelihood function:

$$log f ( t ) = log ( \frac{k}{λ} ) + ( k - 1 ) log ( \frac{t - γ}{λ} ) - {( \frac{t - γ}{λ} )}^{k}$$

As a result, models may overfit the observed data, and as such using log-likelihood loss functions may not lead to accurate predictions.

### 2. Interval Regression

By contrast, embodiments of the present disclosure can use an innovative approach to learn Weibull distribution parameters involving interval regression and the survival function S(t), define as:

$$S ( t ) = 1 - F ( t ) = {e}^{- {( t - γ )}^{k} / λ}$$

Embodiments can further leverage the log-log transform of the survival function, which takes the functional form:

$$log ( - log ( S ( t ) ) = k log ( t - γ ) - log λ$$

Using this as the loss function, embodiments of the present disclosure can use least squares to fit the Weibull distribution parameters k, λ, γ.

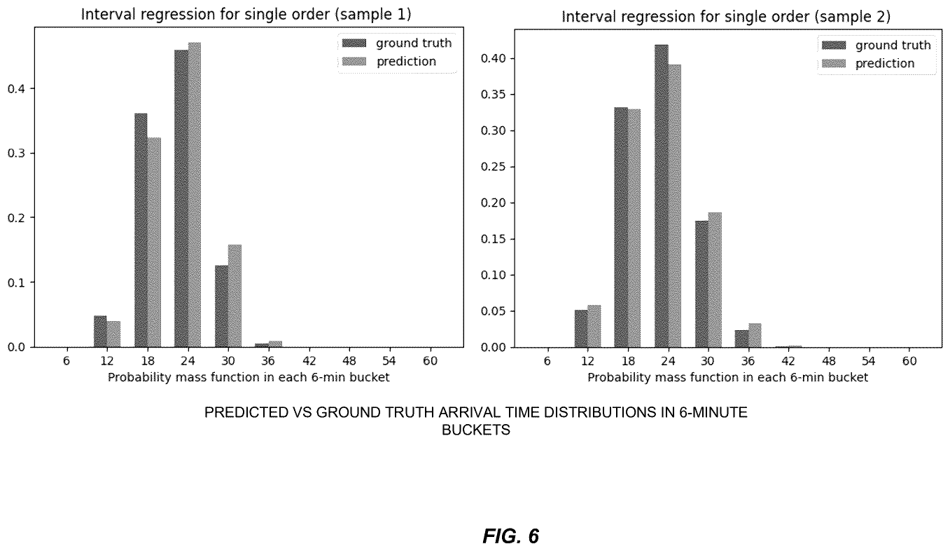

In some embodiments, interval regression can be used to derive the survival function S(t) from data. Fulfillment requests with similar features X can be grouped and used to plot a histogram of the fulfillment request time H(t). In some embodiments, the length of each bucket can be six minutes. FIG. 6 shows two graphs of histograms comparing the predicted and ground truth estimated arrival time distributions in six minute buckets. In some embodiments, the survival function at each time t can be derived by summing the histogram values for t′>t:

$$S ( t ) = {\sum }_{{t}^{′} > t} H ( {t}^{′} )$$

### 3. a Simulation Study

A simulation study was conducted to validate the prediction accuracy of the interval regression approach of some embodiments of the present disclosure. For each fulfillment request with input features X, fixed functions were used to generate the ground truth parameters:

$$k = {f}_{k} ( X ) , λ = {f}_{λ} ( X ) , γ = {f}_{γ} ( X )$$

Given each set of input features X, one million observations were simulated by drawing random samples from the Weibull distribution with these parameters k, λ, γ. These observations formed the training and validation datasets, used to train a multi-head neural network according to embodiments to simultaneously learn functions fₖ, f_{λ}, f_{γ}. The predicted parameters were compared against their ground truth values and used to measure the accuracy of the distribution predictions. The simulation study showed that interval regression approaches according to embodiments greatly reduced overfitting and resulted in more accurate Weibull parameter predictions.

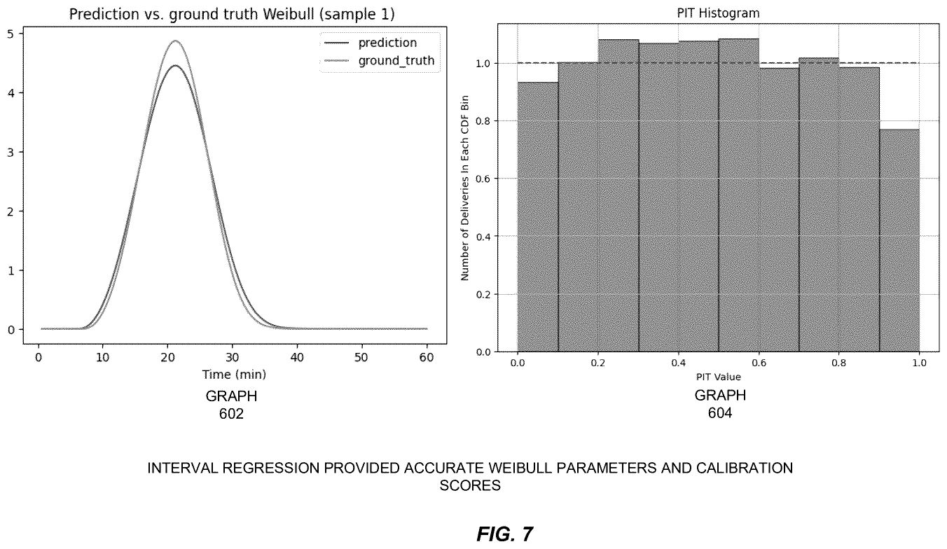

FIG. 7 shows a graph 702 of predicted and ground truth Weibull distributions. In the graph, the ground truth parameters are k=3.37, λ=0.27, and γ=0.11 while their predicted values are k=3.22, λ=0.28, and γ=0.10. As such, graph 702 demonstrates that interval regression methods enable machine learning models according to embodiments to simultaneously learn the shape, scale, and location parameters of the Weibull distribution with high accuracy. Model calibration, as measured by the PIT histogram of graph 704, is also greatly improved as a result.

### IV. MULTITASK LEARNING

As described above, machine learning models according to embodiments, such as machine learning model 242 depicted in FIG. 2, can be used to produce probabilistic estimated arrival time predictions 240 corresponding to various tasks. Two noteworthy tasks are estimated arrival time predictions corresponding to an Explore Stage and a Checkout Stage of a fulfillment request. However, machine learning model 242 can produce probabilistic estimated arrival time predictions 240 for other tasks, such as forecasting transporter supply, preparing recommendations for users, forecasting budget spending, etc. As an example, a probabilistic estimated arrival time prediction can be provided as an input to a recommender system to generate a prediction for ads to display a user. A user can be made to watch stuff they like based on the ads. Generally, estimated arrival time prediction methods according to embodiments can be used in situations in which the costs of inaccuracy are asymmetric and the prediction space is continuous. If over-estimating is less costly than underestimating, a probabilistic forecast can provide “downstream” systems with more granular estimates, which can be converted into a useful estimate via a decision layer.

Furthermore, the structural design of machine learning models according to embodiments can be generalized to different domains by enabling the machine learning models to separately learn implicit interactions (e.g., via the multiple feature encoder), explicit interactions (e.g., via the categorical encoder), and sequential patterns (e.g., via the time series encoder) and dynamically route expert encoders.

### A. Explore Stage and Checkout Stage

Generally, a fulfillment request can be separated into two stages, an “Explore Stage” and a “Checkout Stage.” For example, in the Explore Stage, a user may “explore” which service providers that the user may request items from (e.g., which restaurants the user intends to purchase food from). In the Checkout Stage, a user may “checkout” with their items, initiating the fulfillment request eventually culminating in the delivery of items to the user.

Generally, estimated arrival time predictions can be generated from information associated with either the Explore Stage or the Checkout Stage. For example, for the Explore Stage, an item fulfillment service may have access to user information (e.g., the user's address) and service provider information (e.g., the service provider's address, current demand for the service provider, etc.). Such information can be used to predict the estimated arrival time for the user, prior to the user “checking out” with their fulfillment request, enabling the user to better decide which service providers or items that the user wants to request. By contrast, in the Checkout Stage, the item fulfillment service may have access to fulfillment request information (e.g., indicating which items were requested and in what quantities) in addition to the user features and service provider features from the Explore Stage, and may be used to produce a more accurate arrival time estimate.

There may be inconsistencies between arrival time estimations produced using separate machine learning models during the Explore Stage and the Checkout stage. This can surprise users and undermine user trust in arrival time estimates. One technique to address and mitigate this problem is to enforce an adjustment on later stage estimates (e.g., the Checkout Stage) based on earlier stage estimates (e.g., the Explore Stage). While this technique does improve consistency, it generally reduces accuracy, as later stage estimates are usually more accurate than earlier stage estimates because of better data ability.

By contrast, embodiments of the present disclosure implement a multitask learning approach to address the inconsistency without hurting accuracy. This strategy, described in more detail below, allows embodiments to handle different estimated time of arrival scenarios together, thereby leading to more consistent and efficient predictions.

### B. Shared vs Task-Specific

The tasks of producing both Explore Stage estimated arrival time predictions and Checkout Stage estimated arrival time predictions may have shared labels and shared actual fulfillment request durations, and, for many samples, the service provider and user related features may be similar. As such, the learned relationships between these features and labels can be expected to be similar, and the parameters representing the relationships between features and labels can be shared between these two tasks. However, the availability of fulfillment request information and some real-time information is different in different stages, and Checkout Stage feature value distributions can be different than Explore stage feature distributions and often have higher correlations with labels. As such, in some embodiments, task-specific modules can be used to handle input differences and convert encoded representations into predictions.

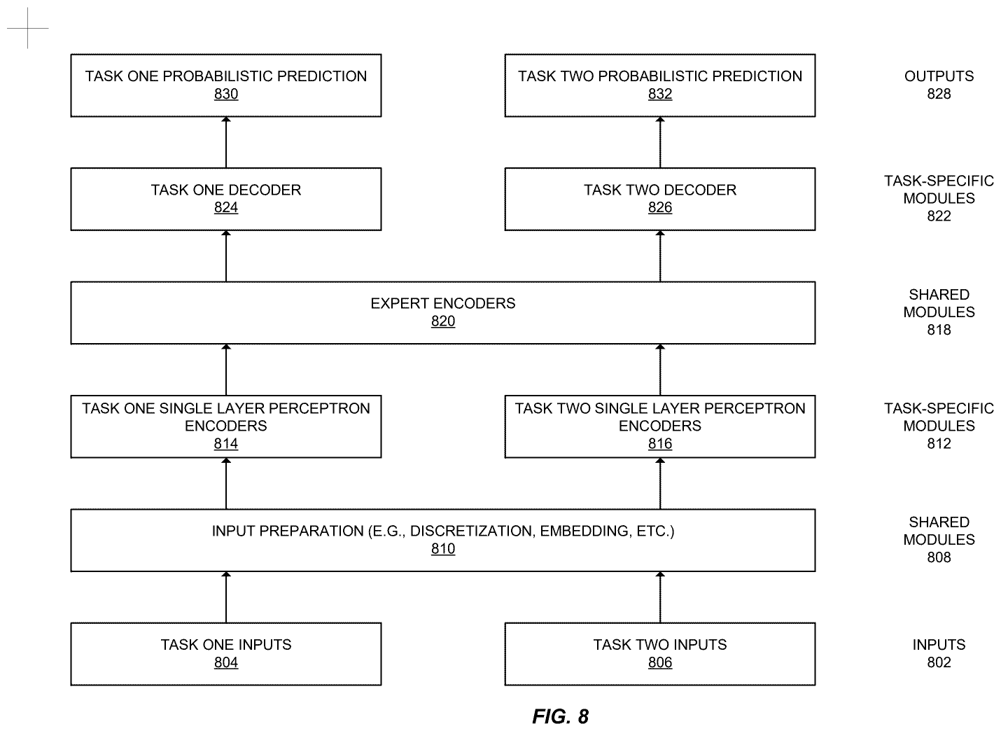

FIG. 8 shows a diagram of multitask training corresponding to two tasks “task one” and “task two” according to some embodiments. Such tasks could comprise, e.g., producing Explore Stage estimated arrival time predictions (e.g., task one) and producing Checkout Stage estimated arrival time predictions (e.g., task two). Multitask training methods according to embodiments can balance the task-specific accuracy and knowledge sharing via “task-specific modules” (e.g., task-specific modules 812 and 822) and “shared modules” (e.g., shared modules 808 and shared modules 818). Such shared modules 808 and 818 can be used based on the observation above that many parameters can be shared between different estimated arrival time prediction tasks, and task-specific modules 812 and 822 can be used to achieve higher task specific accuracy. Such parameters that can be shared between different asks may be considered shared model components. Additional examples of shared model components that can be applied across tasks, models, or within a training system as depicted in FIG. 8 include, but are not limited to, feature stores, pre-trained embeddings, pre-trained models, shared neural network layers, etc.

In general, inputs 802 to the respective tasks (e.g., continuous, numerical, categorical, and time series features as depicted in FIG. 2), i.e., task one inputs 804 and task two inputs 806 can be prepared by input preparation block 810, which can comprise shared modules 808. Such input preparations can include e.g., those described above with reference to input preparation step 210 of FIG. 2, e.g., discretization, generating embeddings, aggregation and position embedding, etc. The prepared inputs can then be applied to task-specific modules 812, which can include task one single layer perceptron encoders 814 and task two single layer perceptron encoders 816, which may be similar to the initial encoders 218 described above with reference to FIG. 2. The outputs of these task-specific modules 812 can comprise the inputs to expert encoders 820, which may be similar to the expert encoders 224 from FIG. 2. These expert encoders 820 can comprise shared modules 818. The outputs of the expert encoders 820 can comprise the inputs of task-specific modules 822, which can comprise task one decoder 824 and task two decoder 826. Task one decoder 824 and task two decoder 826 can be similar to the output layer 236 in FIG. 2. The outputs 828 of these task-specific modules 822 can comprise task one probabilistic prediction 830 (e.g., an Explore Stage estimated arrival time prediction) and task two probabilistic prediction 832 (e.g., a Checkout Stage estimated arrival time prediction). In this way, machine learning models according to embodiments can produce probabilistic estimated arrival time predictions corresponding to various tasks. Although only two tasks are shown in FIG. 8, it should be understood that embodiments of the present disclosure can be practiced with any number of tasks.

### C. Co-Training Vs Sequential Training

Methods according to embodiments can be practiced using either co-training or sequential training approaches. Co-training approaches can be efficient in terms of training time and computational resources and offers the potential for real-time knowledge sharing between tasks. However, co-training can also result in accuracy degradation in each individual tasks (e.g., in embodiments, predicting Explore Stage arrival times and Checkout Stage arrival) due to interference between tasks. By contrast, in sequential training, tasks are trained one after another (e.g., first training a machine learning model to predict Explore Stage arrival times then subsequently training the machine learning model to predict Checkout Stage arrival times). After parameters from one task are learned, those parameters can be frozen and parameters from the other task can be trained. While more time-consuming than co-training, in some embodiments, sequential training can result in more accurate arrival time predictions. By isolating the training process for each task, embodiments of the present disclosure can reduce noise from other tasks and allow for better fine-tuning of task-specific parameters. Methods according to embodiments facilitate effective transfer learning by sharing parameters between tasks while minimizing interference.

In some embodiments, machine learning models can first be trained on Checkout tasks. Once such tasks are well-learned, Checkout-related parameters can be frozen and Explore-specific parameters can be trained. The majority of parameters (e.g., embeddings, expert encoders) can be trained on the Checkout task because it has higher priority and richer information, and the accuracy improvements in the Explore task demonstrate successful knowledge transfer.

### D. Benefits of Multitask Training

By using multitask learning, embodiments of the present disclosure achieve consistent improvements in arrival time estimates across different stages without sacrificing accuracy. Additionally, sequential multitask training methods according to embodiments are more efficient than training separate models for each stage. The shared components result in useful transfer learning between stages, improving Explore task performance from fine-tuned Checkout task models. This presents the possibility of transferring learned patterns to even more tasks in the future.

### V. METHODS

Various methods and corresponding computer readable media and system can be implemented. For example, one or more estimated time of arrivals can be predicted using a mixture of expert encoders. As another example, machine learning model can be trained to generate estimated arrival time predictions. Estimated time of arrivals may be predicted using various features including continuous, categorical, and/or time series features.

### A. Estimated Time of Arrival for Delivery

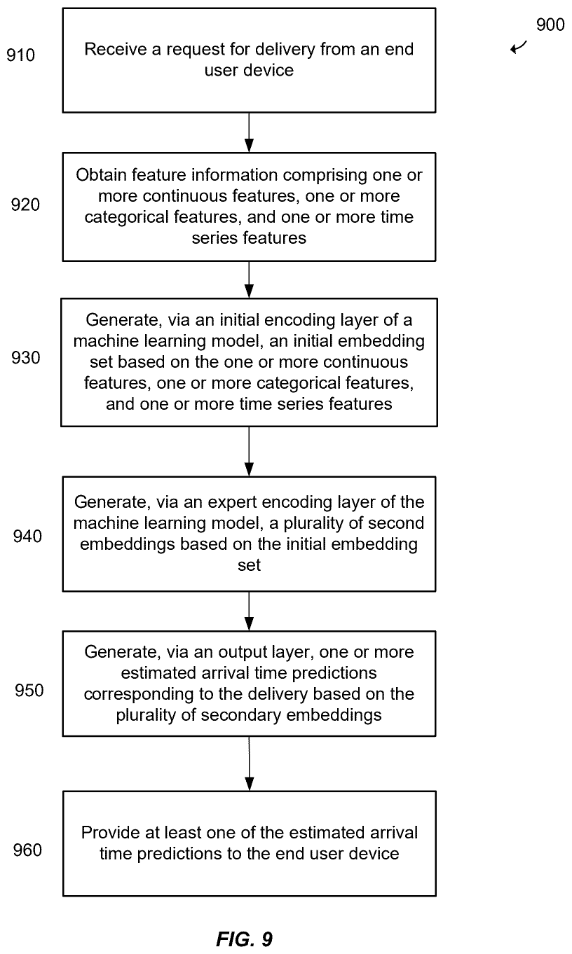

FIG. 9 is a flowchart illustrating a method 900 for determining an estimated time of arrival for delivery, according to some embodiments of the present disclosure. Portions or all steps of method 900 can be performed by a computer system, including one or more processors. The method 900 can use a trained ML model that was trained by the computer system or another computer system. The computer system can comprise various devices, e.g., one device that performed the training and another that uses the trained model.

At step 910, the method 900 can include receiving a request for a delivery from an end user device.

At step 920, the method 900 can include obtaining feature information including one or more continuous features, one or more categorical features, and one or more time series features. The feature information can include retrieval information associated with a retrieval location from which an item is to be delivered by a transporter and transporter information associated with a plurality of transporter devices of transporters that are currently active for the retrieval location.

At step 930, the method 900 can include generating an initial embedding set via an initial encoding layer of a machine learning model. The initial embedding set may be generated based on the one or more continuous features, one or more categorical features, and one or more time series features. The initial embedding set may include one or more continuous feature embeddings, one or more categorical feature embeddings, and one or more positional embeddings. The initial encoding layer may include a single layer perceptron and one or more batch normalization layers. The one or more continuous features can include one or more numerical features.

The initial encoding layer can include a single layer perceptron and one or more batch normalization layers. The single layer perceptron and one or more batch normalization layers may generate one or more normalized inputs based on the feature information, the initial embedding set, or a combination thereof. The one or more normalized inputs have a fixed dimension and may be provided to the expert encoding layer, the output layer, or a combination thereof.

The one or more categorical features can include one or more non-numerical features associated with the delivery. Examples of the one or more non-numerical features include but are not limited to pickup location, drop off location, store type, item taxonomy, etc. The one or more continuous features can include one or more numerical features. Examples of numerical features include but are not limited to travel duration and item fulfillment subtotals. The one or more time series features can include a sequence of time signals obtained during a time period. Each time signal of the sequence of time signals can include one or more data points associated with the delivery and collected during one or more time intervals of the time period. For example, each time signal can be a number of orders per minute obtained over a 20 minute period.

At step 940, the method 900 can include generating a plurality of secondary embeddings based on the initial embedding set. The expert encoding layer can include a time series encoder, and categorical encoder, and a multiple feature encoder. The time series encoder may be or may include a transformer encoder, the categorical encoder may include a crossing mechanism, and the multiple feature encoder may be or may include a deep neural network with a deep component.

Generating the plurality of secondary embeddings generating a time series embedding based on the one or more time series features and the one or more positional embeddings. The time series embedding may be generated by the time series encoder. An implicit interaction embedding may be generated by the multiple feature encoder based on the feature information, the one or more continuous feature embeddings, the one or more categorical feature embeddings, the one or more positional embeddings, or any combination thereof. Additionally or alternatively, the categorical feature encoder may generate an explicit interaction embedding based on the one or more categorical features and the one or more categorical feature embeddings.

At step 950, the method 900 can include generating one or more estimated arrival time predictions via an output layer. The one or more estimated arrival time predictions can correspond to the delivery based on the plurality of secondary embeddings. The one or more estimated arrival time predictions may include a point estimate and/or a distribution estimate. In some examples, a first estimated arrival time is generated prior to the item being selected. Additionally or alternatively, a second estimated arrival time may be generated after the item is selected. The output layer may be or may include a gating mechanism, and the the gating mechanism is associated with (i) a multilayer perceptron, (ii) one or more linear functions, (iii) or any combination thereof.

The one or more estimated arrival time predictions may be generated based on the initial embedding set, the plurality of second embeddings, the feature information, or any combination thereof.

In some examples, the one or more estimated time of arrival predications can include a distribution estimate. The distribution estimate may correspond to a Weibull distribution and may be generated using interval regression.

At step 960, the method can include providing at least one of the estimated arrival time predictions to the end user device.

### B. Training a Machine Learning Model to Generate Estimated Arrival Time Predictions

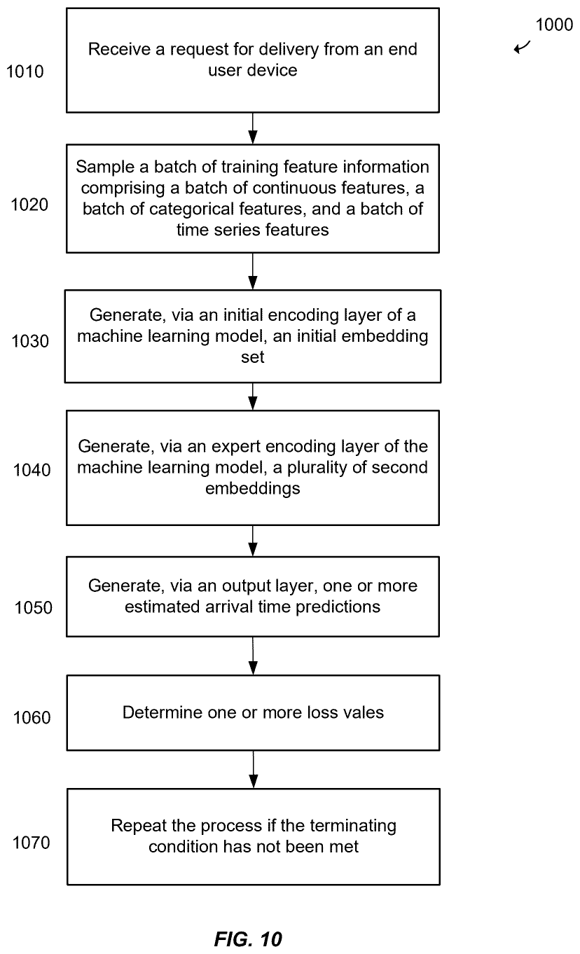

FIG. 10 is a flowchart illustrating a method 1000 for training a machine learning model to generate estimated time predictions, according to some embodiments of the present disclosure. Portions or all steps of method 1000 can be performed by a computer system, including one or more processors. The method 1000 can use a trained ML model that was trained by the computer system or another computer system. The computer system can comprise various devices, e.g., one device that performed the training and another that uses the trained model. The method 1000 can include performing an iterative process until a terminating condition has been met. In some examples, the estimated arrival time predictions can correspond to a first task and a second task. Machine learning model components corresponding to the first task and the second task may be trained sequentially. Additionally or alternatively, machine learning model components corresponding to the first task and the second task can be co-trained.

At step 1010, the method 1000 can include sampling a batch of training feature information including a batch of continuous features, a batch of categorical features, and a batch of time series features.

At step 1020, the method 1000 can include generating an initial embedding set based on the batch of continuous features, the batch of categorical features, and the batch of time series features. The initial embedding may be generated via an initial encoding layer of the machine learning model. The initial encoding layer may include a first task single layer perceptron and a second task single layer perceptron,

At step 1030, the method 1000 can include generating a plurality of secondary embeddings based on the initial embedding set via an expert encoding layer of the machine learning model. The expert encoding layer of the machine learning model can include a time series encoder, a categorical encoder, and a multiple feature encoder.

At step 1040, the method 1000 can include generating one or more estimated arrival time predictions based on the plurality of secondary embeddings via an output layer. The output layer can include a first task multilayer perceptron and a second task multilayer perceptron,

At step 1050, the method 1000 can include determining one or more loss values based on the one or more estimated arrival time predictions.

At step 1060, the method 1000 can include updating a parameter set of the machine learning model based on the one or more loss values, thereby training the machine learning model. In some examples, updating the parameter set includes updating parameter sets corresponding to the first task single layer perceptron, the second task single layer perceptron, the first task multilayer perceptron, and the second task multilayer perceptron. The machine learning model may additionally include one or more shared model components, and updating the parameter set of the machine learning model can include updating one or more parameter sets corresponding to the one or more shared model components.

At step 1070, the method 1000 can include repeating the iterative training process until the terminating condition has been met if the terminating condition has not been met. If the terminating condition has been met, the iterative training process may be completed.

Methods according to embodiments, as described herein, result in a remarkable 20% improvement in estimated time of arrival accuracy. The Mixture of Experts architecture, with parallel encoders and novel combination approaches is adept at handling various scenarios in item fulfillment services. Additionally, advanced feature engineering techniques, which leverage both embeddings and time series data, enhance machine learning model's ability to capture nuanced patterns and temporal dependencies, and improve model responsiveness to real time changes. Further, multitask learning approach according to embodiments, which can employ sequential training, can improve consistency across various arrival time estimate scenarios while facilitating knowledge transfer between tasks. Additionally, the introduction of probabilistic predictions enrich predictions with probabilistic context. These advancements can lead to more efficient logistics, improved user satisfaction, and a more seamless experience for users, transporters, and service providers.

### VI. COMPUTER SYSTEM

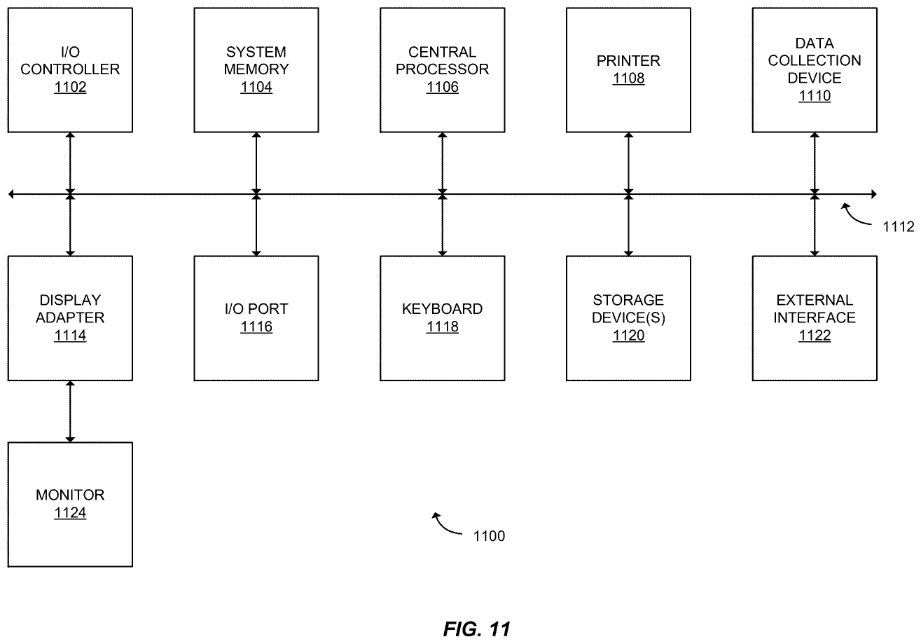

Any of the computer systems mentioned herein may utilize any suitable number of subsystems. Examples of such subsystems are shown in FIG. 11 in computer system 1100. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 11 are interconnected via a system bus 1112. Additional subsystems such as a printer 1108, keyboard 1118, storage device(s) 1120, monitor 1124 (e.g., a display screen, such as an LED), which is coupled to display adapter 1114, and others are shown. Peripherals and input/output (I/O) devices, which couple to I/O controller 1102, can be connected to the computer system by any number of means known in the art such as input/output (I/O) port 1116 (e.g., USB, FireWire®). For example, I/O port 1116 or external interface 1122 (e.g. Ethernet, Wi-Fi, etc.) can be used to connect computer system 1100 to a wide area network such as the Internet, a mouse input device, or a scanner. The interconnection via system bus 1112 allows the central processor 1106 to communicate with each subsystem and to control the execution of a plurality of instructions from system memory 1104 or the storage device(s) 1120 (e.g., a fixed disk, such as a hard drive, or optical disk), as well as the exchange of information between subsystems. The system memory 1104 and/or the storage device(s) 1120 may embody a computer readable medium. Another subsystem is a data collection device 1110, such as a camera, microphone, accelerometer, and the like. Any of the data mentioned herein can be output from one component to another component and can be output to the user.

A computer system can include a plurality of the same components or subsystems, e.g., connected together by external interface 1122, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

### VII. REFERENCES

Argerich, L., Zaffaroni, J. T., Cano, M. J. (2016). Hash2Vec, Feature Hashing for Word Embeddings. arXiv preprint arXiv:1608.08940.
Guo, H., TANG, R., Ye, Y., Li, Z., & He, X. (2017). DeepFM: A factorization-machine based neural network for CTR prediction. arXiv preprint arXiv:1703.04247. https://doi.org/10.48550/arXiv.1703.04247
Khaledian, A., Ghadiridehkordi, A., Khaledian, N. (2025). PCA-RAG: Principal Component Analysis for Efficient Retrieval-Augmented Generation. arXiv preprint arXiv:2504.08386. https://doi.org/10.48550/arXiv.2504.08386
Li, H., Zhang, Y., Zhang, Y., Li, H., Sang, L., Zhu, J. (2024). DCNv3: Towards Next Generation Deep Cross Network for Click-Through Rate Prediction. arXiv preprint arXiv:2407.13349v1.
Lian, J., Zhou, X., Zhang, F., Chen, Z., Xie, X., & Sun, G. (2018). XDeepFM: Combining Explicit and Implicit Feature Interactions for Recommender Systems. arXiv preprint arXiv:1803.05170.
Qiu, J., Dong, Y., Ma, H., Li, J., Wang, C., Wang, K., & Tang, J. (2019). NETSMF: Large-scale network embedding as sparse matrix factorization. The World Wide Web Conference, 1509-1520. https://doi.org/10.1145/3308558.3313446
Song, W., Shi, C., Xiao, Z., Duan, Z., Xu, Y., Zhang, M., & Tang, J. (2019). AutoInt: Automatic Feature Interaction Learning via Self-Attentive Neural Networks. arXiv preprint arXiv:1810.11921.
Wang, F., Gu, H., Li, D., Lu, T., Zhang, P., Gu, N. (2023). Towards Deeper, Lighter and Interpretable Cross Network for CTR Prediction. arXiv preprint arXiv:2311.04635.
Wang, R., Shivanna, R., Cheng, D. Z., Jain, S., Lin, D., Hong, L., Chi, E. H. (2020). DCN V2: Improved Deep & Cross Network and Practical Lessons for Web-scale Learning to Rank Systems. arXiv preprint arXiv:2008.13535.
Zhou, J., Yu, Q. (2023). DCRNN: A Deep Cross approach based on RNN for Partial Parameter Sharing in Multi-task Learning. arXiv preprint arXiv:2310.11777.

What is claimed is:

1. A computer-implemented method comprising:
receiving, from an end user device, a request for a delivery;
obtaining feature information comprising one or more continuous features, one or more categorical features, and one or more time series features, wherein the feature information includes (1) retrieval information associated with a retrieval location from which an item is to be delivered by a transporter and (2) transporter information associated with a plurality of transporter devices of transporters that are currently active for the retrieval location;
generating, via an initial encoding layer of a machine learning model, an initial embedding set based on the one or more continuous features, the one or more categorical features, and the one or more time series features;
generating, via an expert encoding layer of the machine learning model, a plurality of secondary embeddings based on the initial embedding set, wherein the expert encoding layer comprises a time series encoder, a categorical encoder, and a multiple feature encoder;
generating, via an output layer, one or more estimated arrival time predictions corresponding to the delivery based on the plurality of secondary embeddings; and
providing, to the end user device, at least one of the estimated arrival time predictions.

2. The computer-implemented method of claim 1, wherein the one or more estimated arrival time predictions comprises a point estimate and/or a distribution estimate.

3. The computer-implemented method of claim 1, wherein a first estimated arrival time prediction of the one or more estimated arrival time predictions is generated prior to the item being selected.

4. The computer-implemented method of claim 3, wherein a second estimated arrival time prediction of the one or more estimated arrival time predictions is generated after the item is selected.

5. The computer-implemented method of claim 1, wherein:
the time series encoder comprises a transformer encoder;
the categorical encoder comprises a deep neural network comprising a cross-interaction mechanism; and
the multiple feature encoder comprises a deep neural network with a deep component.

6. The computer-implemented method of claim 1, wherein:
the initial embedding set comprises one or more continuous feature embeddings, one or more categorical feature embeddings, and one or more positional embeddings; and
generating the plurality of secondary embeddings comprises:
generating, by the time series encoder, a time series embedding based on the one or more time series features and the one or more positional embeddings,
generating, by the multiple feature encoder, an implicit interaction embedding based on the feature information, the one or more continuous feature embeddings, the one or more categorical feature embeddings, the one or more positional embeddings, or any combination thereof, and
generating, by the categorical encoder, an explicit interaction embedding based on the one or more categorical features and the one or more categorical feature embeddings.

7. The computer-implemented method of claim 1, wherein the one or more categorical features comprise one or more non-numerical features associated with the delivery, the one or more non-numerical features comprising pickup location, drop off location, store type, item taxonomy, or any combination thereof.

8. The computer-implemented method of claim 1, wherein the one or more time series features comprise a sequence of time signals obtained during a time period, and wherein each time signal of the sequence of time signals comprises one or more data points associated with the delivery and collected during one or more time intervals of the time period.

9. The computer-implemented method of claim 1, wherein the output layer comprises a gating mechanism, and wherein the gating mechanism is associated with (i) a multilayer perceptron, (ii) one or more linear functions, (iii) or any combination thereof.

10. The computer-implemented method of claim 1, wherein the one or more estimated arrival time predictions are generated based on the initial embedding set, the plurality of second embeddings, the feature information, or any combination thereof.

11. The computer-implemented method of claim 1, wherein the initial encoding layer includes a single layer perceptron and one or more batch normalization layers.

12. The computer-implemented method of claim 11, further comprising:
generating, by the single layer perceptron and one or more batch normalization layers, one or more normalized inputs based on the feature information, the initial embedding set, or a combination thereof, wherein the one or more normalized inputs have a fixed dimension; and
providing the one or more normalized inputs to the expert encoding layer, the output layer, or a combination thereof.

13. The computer-implemented method of claim 1, wherein the one or more estimated arrival time predictions comprise a distribution estimate, wherein the distribution estimate corresponds to a Weibull distribution and is generated using interval regression.

14. The computer-implemented method of claim 1, wherein the one or more continuous features include one or more numerical features, and wherein the one or more numerical features comprise travel duration and item fulfillment subtotals.

15. A computer-implemented method for training a machine learning model to generate estimated arrival time predictions, the method comprising performing an iterative training process until a terminating condition has been met, the iterative training process comprising:
sampling a batch of training feature information comprising a batch of continuous features, a batch of categorical features, and a batch of time series features;
generating, via an initial encoding layer of the machine learning model, an initial embedding set based on the batch of continuous features, the batch of categorical features, and the batch of time series features;
generating, via an expert encoding layer of the machine learning model, a plurality of secondary embeddings based on the initial embedding set, the expert encoding layer of the machine learning model comprising a time series encoder, a categorical encoder, and a multiple feature encoder;
generating, via an output layer, one or more estimated arrival time predictions based on the plurality of secondary embeddings;
determining one or more loss values based on the one or more estimated arrival time predictions;
updating a parameter set of the machine learning model based on the one or more loss values, thereby training the machine learning model; and
if the terminating condition has not been met, repeating the iterative training process until the terminating condition has been met, otherwise completing the iterative training process.

16. The computer-implemented method of claim 15, wherein the estimated arrival time predictions correspond to a first task and a second task, wherein the initial encoding layer includes a first task single layer perceptron and a second task single layer perceptron, wherein the output layer includes a first task multilayer perceptron and a second task multilayer perceptron, and wherein updating a parameter set of the machine learning model based on the one or more loss values comprises updating parameter sets corresponding to the first task single layer perceptron, the second task single layer perceptron, the first task multilayer perceptron, and the second task multilayer perceptron.

17. The computer-implemented method of claim 16, wherein machine learning model components corresponding to the first task and the second task are trained sequentially.

18. The computer-implemented method of claim 16, wherein machine learning model components corresponding to the first task and the second task are co-trained.

19. The computer-implemented method of claim 16, wherein the machine learning model additionally comprises one or more shared model components, and wherein updating the parameter set of the machine learning model comprises updating one or more parameter sets corresponding to the one or more shared model components.

20. A computing device comprising:
one or more processors; and
a non-transitory computer readable medium coupled to the one or more processors, the non-transitory computer readable medium containing instructions for causing the one or more processors to perform a method comprising:
receiving, from an end user device, a request for a delivery;
obtaining feature information comprising one or more continuous features, one or more categorical features, and one or more time series features, wherein the feature information includes (1) retrieval information associated with a retrieval location from which an item is to be delivered by a transporter and (2) transporter information associated with a plurality of transporter devices of transporters that are currently active for the retrieval location;
generating, via an initial encoding layer of a machine learning model, an initial embedding set based on the one or more continuous features, the one or more categorical features, and the one or more time series features;
generating, via an expert encoding layer of the machine learning model, a plurality of secondary embeddings based on the initial embedding set, wherein the expert encoding layer comprises a time series encoder, a categorical encoder, and a multiple feature encoder;
generating, via an output layer, one or more estimated arrival time predictions corresponding to the delivery based on the plurality of secondary embeddings; and
providing, to the end user device, at least one of the estimated arrival time predictions.
